(19) United States
(12) Patent Application Publication
(10) Pub. No.: US 2026/0066489 A1
(43) Pub. Date: Mar. 5, 2026

(54) Electrode Lead Structure for Secondary Battery and Lithium Secondary Battery Including the Same

(71) Applicant: SK On Co., Ltd., Seoul (KR)

(72) Inventors: Ga Yeong YOO, Daejeon (KR); Young Ha KIM, Daejeon (KR); Ho Jin HWANG, Daejeon (KR)

(21) Appl. No.: 19/313,942

(22) Filed: Aug. 29, 2025

(30) Foreign Application Priority Data
Aug. 30, 2024 (KR) 10-2024-0117334

(51) Int. Cl. H01M 50/533; H01M 50/178; H01M 50/536; H01M 50/54; H01M 50/548; H01M 50/557

(52) U.S. Cl. CPC H01M 50/533; H01M 50/178; H01M 50/536; H01M 50/54; H01M 50/548; H01M 50/557

(57) ABSTRACT

Provided are an electrode lead structure for a secondary battery and a secondary battery including the same. The electrode lead structure includes an electrode lead and a lead film, wherein the electrode lead includes a first lead portion to which an electrode tab is bonded, a second lead portion, having a thickness less than that of the first lead portion, and a third lead portion formed between the first lead portion and the second lead portion and having a slope in which a thickness increases in a direction from the second lead portion to the first lead portion, and the lead film is positioned on the third lead portion.

### CROSS-REFERENCE TO RELATED APPLICATION(S)

This patent document claims the priority and benefits of Korean Patent Application No. 10-2024-0117334 filed on Aug. 30, 2024, the disclosure of which is incorporated herein by reference in its entirety.

### TECHNICAL FIELD

The disclosure and implementations disclosed in this patent document generally relate to an electrode lead structure for a secondary battery and a lithium secondary battery including the same.

### BACKGROUND

As the application of secondary batteries has been diversified, demand for batteries with high energy density has also gradually increased. In order to implement high-energy density batteries, the use of silicon-based anode materials together with graphite-based anode materials has also increased, and research has been actively conducted to gradually increase the usage amount of silicon-based anode materials.

The silicon-based anode materials have a characteristic of greater shrinkage and swelling of volume during a charging and discharging process of batteries than the graphite-based anode material.

In addition, when batteries deteriorate due to continuous use of the batteries, electrodes and the secondary batteries themselves expand.

When such shrinkage and swelling processes of batteries are continuously repeated, pressure is applied to electrode tabs, and in particular, an electrode tab located at the outermost part of batteries receives greater pressure due to shrinkage and swelling, which may easily cause disconnection of the electrode tab.

In the event of the disconnection of the electrode tab, an outer electrode cannot participate in charging and discharging, which may cause lithium precipitation due to a cathode to anode (CA) reverse phenomenon or problems, such as shortened battery lifespan and deteriorated storage performance.

### SUMMARY

The present disclosure may be implemented in some embodiments to improve the stability of a battery by preventing the disconnection of an electrode tab.

The present disclosure may be implemented in some embodiments to provide a secondary battery suppressed in shortened battery life and deteriorated storage performance.

In some embodiments of the present disclosure, an electrode lead structure for a secondary battery includes: an electrode lead and a lead film, wherein the electrode lead includes a first lead portion; a second lead portion, having a thickness less than that of the first lead portion; and a third lead portion formed between the first lead portion and the second lead portion and having a slope in which a thickness increases in a direction from the second lead portion to the first lead portion, and the lead film is positioned on the third lead portion.

The first lead portion may be less than a thickness of an electrode assembly.

The thickness of the second lead portion may be 200 μm to 1.2 mm.

The electrode lead may be a negative electrode lead, and the thickness of the second lead portion may be 200 μm to 600 μm.

The electrode lead may be a positive electrode lead, and the thickness of the second lead portion may be 200 μm to 1 mm.

A thickness ratio of the first lead portion and the second lead portion may be 1.1 to 3:1.

A width of the third lead portion may be greater than a width of the lead film.

A width of the third lead portion may be 10 to 30% greater than a width of the lead film.

The slope of the third lead portion may be formed only on one surface of the electrode lead.

The slope of the third lead portion may be formed on both surfaces of the electrode lead.

In the slope formed on both surfaces, slope angles between the first lead portion and the second lead portion may be different from each other.

In some embodiments of the present disclosure, a secondary battery includes: an n electrode assembly; an electrode tab disposed at at least one end portion of the electrode assembly; and an electrode lead structure bonded to the electrode tab, wherein an electrode lead structure includes an electrode lead and a lead film, wherein the electrode lead includes a first lead portion; a second lead portion, having a thickness less than that of the first lead portion; and a third lead portion formed between the first lead portion and the second lead portion and having a slope in which a thickness increases in a direction from the second lead portion to the first lead portion, and the lead film is positioned on the third lead portion.

The electrode tab may be bonded to one surface or both surfaces of the first lead portion of the electrode lead structure.

The secondary battery may be a lithium secondary battery.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating a secondary battery;

FIG. 2 is an exploded perspective view of the secondary battery of FIG. 1;

FIG. 3 is a plan view schematically illustrating an electrode lead structure according to an embodiment of the present disclosure;

FIG. 4 is a plan view schematically illustrating an electrode lead according to an embodiment of the present disclosure;

FIG. 5 is a cross-sectional view of an electrode lead according to an embodiment of the present disclosure;

FIG. 6 is a cross-sectional view of an electrode lead according to another embodiment of the present disclosure;

FIG. 7 is a partial cross-sectional view of a secondary battery including an electrode lead structure to which the electrode lead illustrated in FIG. 5 is applied according to an embodiment; and

FIG. 8 is a partial cross-sectional view of a secondary battery including an electrode lead structure to which the electrode lead illustrated in FIG. 6 is applied according to an embodiment.

### DETAILED DESCRIPTION

Hereinafter, the present disclosure will be described in detail with reference to the accompanying drawings. However, this is merely an example and the present disclosure is not limited to the specific embodiments described by way of example.

The present disclosure provides an electrode lead structure and also provides a secondary battery including the electrode lead structure.

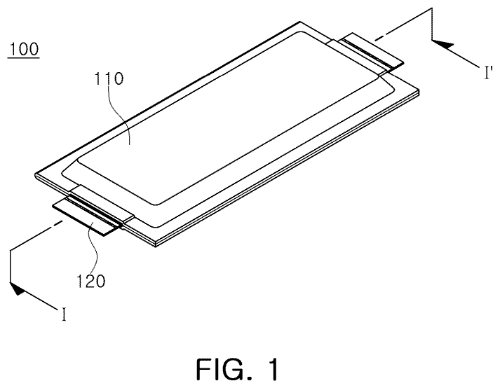

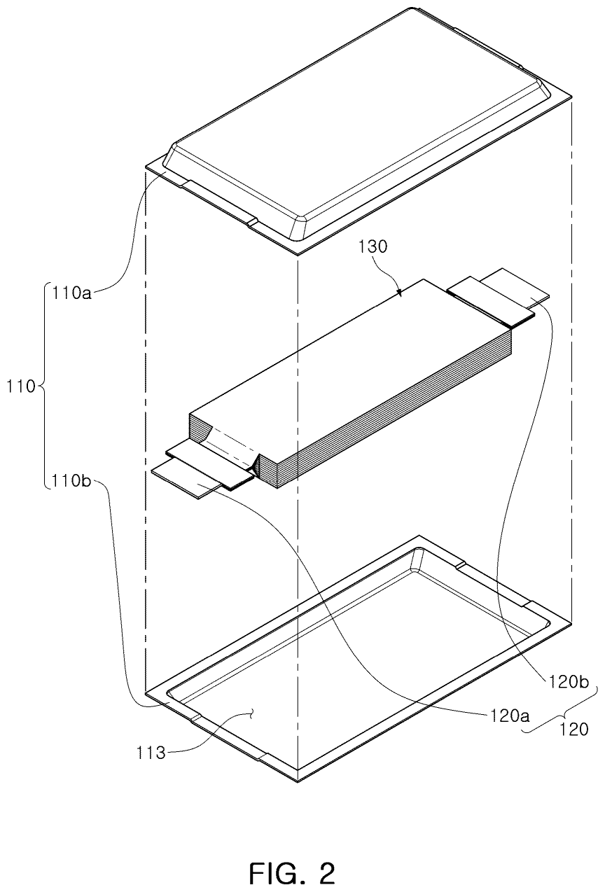

The secondary battery accommodates an electrode assembly in a battery case, and an electrode lead is drawn out through one side or both sides of the battery case to be electrically connected to an external device or an external power source. The secondary battery according to an embodiment of the present disclosure is schematically illustrated in FIGS. 1 and 2.

The battery case is not particularly limited but may be a metal case, such as a square or cylindrical aluminum case, and may be a pouch case. FIG. 1 schematically illustrates an example of a pouch-type secondary battery in which the battery case is a pouch case, and FIG. 2 schematically illustrates an exploded perspective view of the pouch-type secondary battery.

As illustrated in FIGS. 1 and 2, the pouch-type secondary battery 100 may be obtained by accommodating an electrode assembly 130 inside a pouch-type battery case 110, drawing out positive and negative electrode leads 120 (120a and 120b) in one or both directions of the battery case, and sealing the edges of the battery case to form a sealing portion.

Here, the battery case may include an upper case 110a and a lower case 110b, and the upper case and the lower case may be separated as illustrated in FIG. 2 or may be connected to each other at one side thereof, and the secondary battery may be manufactured by sealing the edges of the upper case and the lower case in a facing manner with the electrode assembly received in an accommodation space formed by the upper case and the lower case.

As illustrated in FIG. 2, the battery case may have a storage space 113 formed in both the upper case and the lower case to store the electrode assembly. Alternatively, the storage space may be formed in only one of the upper case and the lower case.

The electrode assembly stored in the battery case may be an electrode assembly in which a positive electrode and a negative electrode are alternately stacked and a separator is interposed between the positive electrode and the negative electrode. The electrode assembly is not illustrated in the drawing, but it may be a stack-type laminate in which the negative electrode, the separator, the positive electrode, and the separator are sequentially stacked, as is obvious to those skilled in the art. Alternatively, the electrode assembly may be a laminate in which one or more separators elongated in one direction are wound in one direction and the positive electrode and the negative electrode are sequentially inserted and stacked or may be a stack-and-folding type laminate in which the positive electrode and the negative electrode are sequentially inserted and stacked while folding the separator in a zigzag form.

The positive electrode and the negative electrode constituting the electrode assembly may be manufactured by applying an electrode mixture slurry including an electrode active material to one surface or both surfaces of an electrode current collector and then drying the same to form an electrode mixture layer. Here, a portion of the electrode current collector may include a region in which the electrode mixture layer is not formed, i.e., an electrode uncoated portion.

The electrode uncoated portion protrudes outwardly from the electrode and functions as an electrode tab, and the electrode tab extends to be bonded to an electrode lead of the electrode lead structure so as to be electrically connected to an external instrument, such as an external power source or an external device.

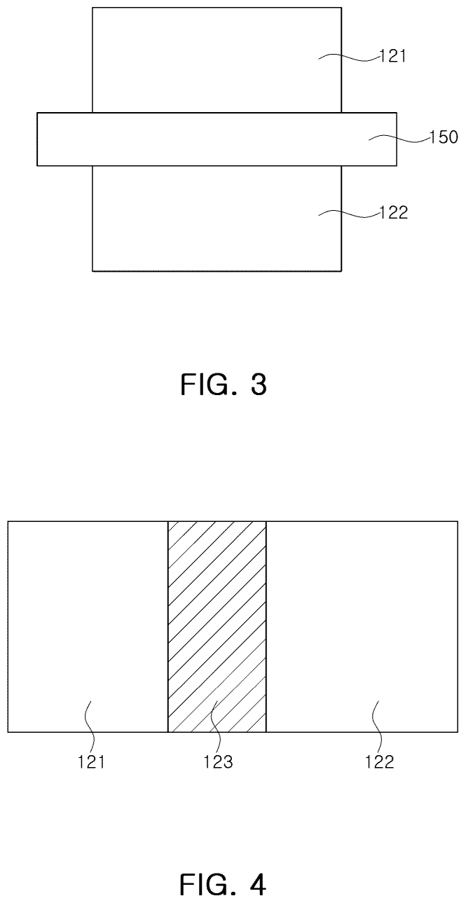

A plan view of the electrode lead structure is schematically illustrated in FIG. 3. As illustrated in FIG. 3, an electrode lead structure 200 may include an electrode lead 120 and a lead film 150. That is, the electrode lead structure may electrically connect the electrode assembly received inside the pouch-type battery case to a power source or an external device outside the pouch-type battery case. The electrode lead may include one side bonded to the electrode tab inside the battery case and the other side drawn out to the outside of the battery case and electrically connected to an external power source or an external device.

The pouch-type battery case is a structure sealing the internal electrode assembly and physically or chemically blocking the electrode assembly from the outside, and a sealing portion sealing the edges of the upper case and the lower case may be formed on a surface of a portion of the electrode lead. Here, since a sealing layer of the pouch case and the electrode lead may be formed of different materials, the lead film 150 may be included in a portion of the surface of the electrode lead to secure sealing tightness and sealing strength. The upper and lower cases of the pouch may respectively sealed with upper and lower surfaces of the lead film in a facing manner.

A plan view of the electrode lead 120 constituting the electrode lead structure is schematically illustrated in FIG. 4. As illustrated in FIG. 4, the electrode lead 120 may include a first lead portion 121, a second lead portion 122, and a third lead portion 123. Specifically, the first lead portion and the second lead portion are regions located at both ends of the electrode lead, and one of the first lead portion and the second lead portion is bonded to the electrode tab, and the other is located outside the battery case and electrically connected to an external device. The third lead portion may be located between the first lead portion and the second lead portion.

The positions of the first lead portion and the second lead portion are not fixed, but for the convenience of description, a region located inside the battery case and bonded to the electrode tab may be referred to as a first lead portion, a region located outside the battery case and electrically connected to an external device may be referred to as a second lead portion, and a region located between the first lead portion and the second lead portion and having a lead film located on at least one surface to form a sealing portion of the battery case may be referred to as a third lead portion.

In terms of the cross-sectional shape of the electrode lead, a thickness h1 of the first lead portion may be greater than a thickness h2 of the second lead portion (h1>h2). Accordingly, the third lead portion may be formed having the thickness gradually increasing from the second lead portion toward the first lead portion.

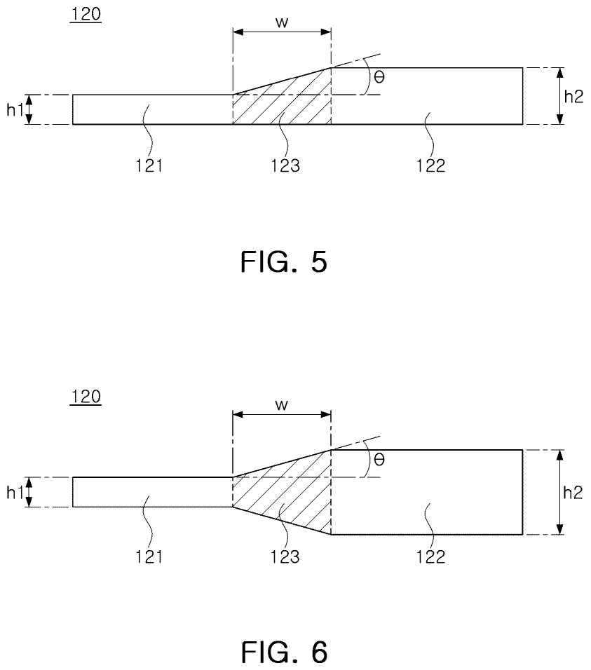

Examples of the cross-sectional shapes of the electrode leads are schematically illustrated in FIGS. 5 and 6. As illustrated in FIG. 5, the electrode lead may include the third lead portion having a slope on only one surface. Accordingly, as illustrated in FIG. 5, one surface may be flat and not sloped, and the other surface may have a shape in which the thickness increases from the second lead portion toward the first lead portion.

In addition, as illustrated in FIG. 6, the electrode lead may have a slope on both sides in which the thickness increases from the second lead portion toward the first lead portion. Here, a slope angle (θ) of the first surface and the second surface may be the same or different. For example, a slope angle may be large on one surface so that the thickness may increase rapidly, and the slope angle may be small on the other surface so that the thickness may increase gradually.

In the electrode lead, the thickness h2 of the second lead portion is not particularly limited. The thickness of the second electrode lead may have a thickness of a commonly applied electrode lead. For example, the second lead portion may be 200 μm to 1.2 mm, and specifically, may be 200 μm to 1 mm. More specifically, in the positive electrode lead, the second lead portion may have a thickness of 200 to 600 μm, and in the negative electrode lead, the second lead portion may have a thickness of 200 μm to 1 mm.

In the electrode lead, the thickness h1 of the first lead portion may be greater than the thickness h2 of the second lead portion. When the thickness of the first lead portion is greater than the thickness of the second lead portion, an upper limit thereof is not particularly limited, but, for example, the thickness of the first lead portion may be smaller than the thickness of the electrode assembly. More specifically, the thickness of the first lead portion may be 90% or less of the thickness of the electrode assembly. For example, the thickness of the first lead portion may be less than a value of Equation 1 below.

[thickness of electrode assembly]−[(thickness of positive electrode current collector×number of positive electrodes)+(thickness of negative electrode current collector×number of negative electrodes)] [Formula 1]

Meanwhile, the relationship between the thickness of the first lead portion and the thickness of the second lead portion is not particularly limited as long as it satisfies the conditions described above, but, for example, the ratio of the thickness of the first lead portion and the thickness of the second lead portion may be 1.1 to 3:1.

Meanwhile, the third lead portion is a region to which a lead film may be attached, and a width w of the third lead portion may be greater than the width of the lead film, and an upper limit thereof is not particularly limited. For example, the width of the third lead portion may be 10 to 30% greater than the width of the lead film. That is, when the width of the lead film is w_{(lf)}, the width w of the third lead portion may be 1.1 w_{(lf)} or more and 1.3 w_{(lf)} or less.

For example, in the process of bonding the electrode tab and the electrode lead by a method, such as ultrasonic welding, ultrasonic welding may be performed by applying high-frequency ultrasonic vibration of approximately 20 KHz. The high-frequency vibration energy is converted into heat energy by friction at the boundary between the electrode tabs or between the electrode tab (or an electrode tab gathering portion 132) and the electrode lead, and accordingly, the bonded portion to be rapidly welded.

This ultrasonic welding applied during the process of bonding the electrode tab and the electrode lead may cause tension in the electrode tab. In particular, in the case of the electrode tab extending from the electrode located at an outer portion of the electrode assembly, a greater tension may be applied, and since these electrode tabs are bent at a large angle for bonding with the electrode lead, the large tension may cause damage to the vicinity of the welded portion of the electrode tab and increase fatigue.

Meanwhile, as the charging and discharging cycle of the lithium secondary battery progresses, deterioration may progress, and as a result, the volume expansion of the electrode or battery may occur. In addition, due to the recent increase in demand for high-energy density batteries, cases of using silicon-based negative electrode active materials as negative electrode active materials has increased, and accordingly, the increase in the volume of the negative electrode during the charging process may become more prominent.

The increase in volume due to the use of such silicon-based negative electrode active materials may maximize the tension of the electrode tab with increased fatigue, especially, the electrode tab located at the outermost portion. This may cause a disconnection near the welded portion of the electrode tab and the electrode lead, thereby cutting off the electrical connection. Therefore, the disconnected electrode may not have a charge/discharge reaction, which may induce a CA reverse phenomenon.

However, when the electrode lead having a structure in which the thickness of the first lead portion is greater than that of the second lead portion as provided in the present disclosure is applied, a distance to a position at which the electrode tab is welded on the electrode lead may be shortened, so that the tension applied to the electrode tab may be effectively relieved. In addition, a bending angle near the electrode tab welded on the electrode lead may be formed to be gentle, so that mechanical damage applied to the electrode tab may be reduced.

Therefore, even in a situation in which the shrinkage and swelling of the battery occurs significantly due to the inclusion of a silicon-based negative electrode active material in the negative electrode or in which shrinkage and swelling are induced due to deterioration of the battery, and thus a significant tension is applied to the electrode tab, the tension applied to the electrode tab may be effectively reduced, so that, in particular, the disconnection of the electrode tab protruding from the electrode located at the outermost portion of the electrode assembly may be prevented. Furthermore, by preventing the disconnection of the electrode tab, the electrical connection between the electrode tab and the electrode lead may be maintained more stably, thereby improving the safety of the battery.

As an embodiment of the present disclosure, the electrode tabs extending from each electrode constituting the electrode assembly may be bonded to a first surface of the first lead portion.

As another embodiment, the electrode tabs may be separated into two regions and bonded to the first surface and the second surface of the electrode lead, respectively. Since the electrode tabs are bonded to both surfaces of the electrode lead, the tension applied to the electrode tabs may be more effectively distributed, which is particularly advantageous in preventing the disconnection of the electrode tabs extending from the electrodes located at the outermost side. The number of electrode tabs bonded to the first and second surfaces of the electrode lead may be the same or different from each other.

The electrode lead according to the present disclosure may include the third lead portion in which the thickness of at least one surface gradually increases in the direction from the second lead portion to the first lead portion. As the thickness of the third lead portion increases in one direction, the flow of current through the electrode lead may be improved, so that electrical resistance is reduced and heat generation near the electrode tab may be suppressed.

Meanwhile, simply forming the entire electrode lead to have greater thickness may secure the effects of preventing the disconnection of the electrode tabs, reducing resistance, or suppressing heat generation, as described above. However, in this case, the lead film attached to the third lead portion may not be tightly attached to the side surface of the electrode lead and may be separated from the electrode lead, or adhesive strength between the electrode lead and the lead film may be weakened. Such a gap and poor adhesion between the electrode lead and the lead film may cause problems, such as electrolyte leakage or gas venting because the battery case is sealed on the lead film, which may ultimately lead to a decrease in battery performance or shortened lifespan.

Therefore, by including the third lead portion having the thickness increasing from the second lead portion toward the first lead portion, while forming the first lead portion to have the thickness greater than that of the second lead portion as described above, the lead film may be more airtightly attached to both surfaces of the electrode lead, thereby preventing problems of electrolyte leakage or gas venting.

The electrode lead for a secondary battery provided in the present disclosure may be formed of a material that may be used as an electrode current collector and may be formed of a material of the electrode current collector described below. For example, the positive electrode lead may be formed of aluminum (Al) foil, and the negative electrode lead may be formed of copper (Cu) foil. However, the present disclosure is not limited thereto.

The present disclosure discloses a secondary battery, and the secondary battery includes an electrode assembly, an electrode tab disposed at at least one end portion of the electrode assembly, and an electrode lead structure coupled to the electrode tab. The electrode lead structure includes an electrode lead and a lead film, and the electrode lead includes a first lead portion; a second lead portion bonded to the electrode tab and having a thickness less than the first lead portion; and a third lead portion formed between the first lead portion and the second lead portion and having a slope increasing in thickness in a direction from the second lead portion to the first lead portion, and the lead film is positioned on the third lead portion.

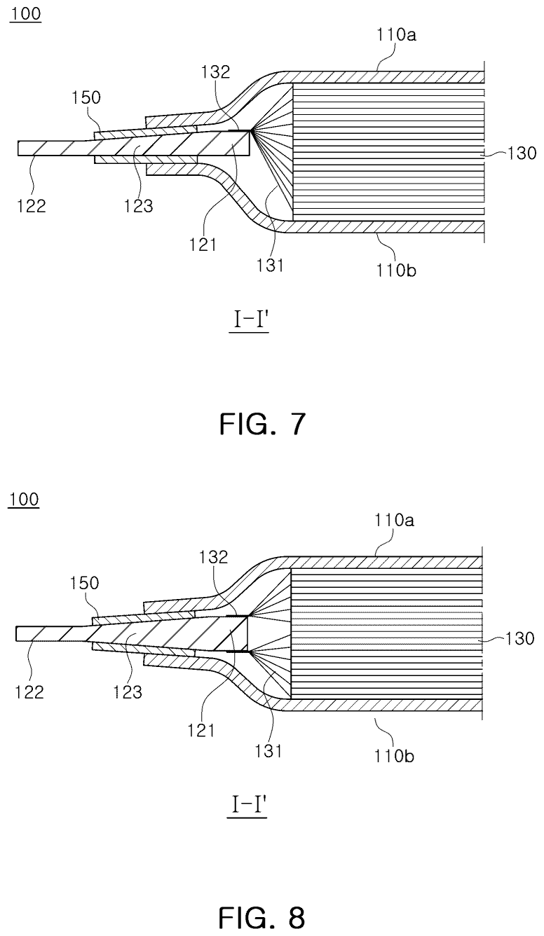

An example of the secondary battery according to the present disclosure is schematically illustrated in FIGS. 7 and 8, and FIGS. 7 and 8 illustrate a portion of a cross-section taken along line I-I′ of the secondary battery of FIG. 1.

FIG. 7 illustrates an example of the secondary battery including an electrode lead as illustrated in FIG. 5, and having an electrode tab bonded to one surface of the electrode lead structure, more specifically, one surface having a slope in which the thickness of the electrode lead structure increases. As illustrated in the FIG. 7, an electrode uncoated portion extending from the electrode current collector of each electrode is provided as an electrode tab 131, and the electrode tab is bonded to one side of the electrode lead 120 to form an electrode tab bonded portion in the first lead portion region and may be electrically connected to an external instrument, such as an external power source or an external device, through the second lead portion. Meanwhile, although not illustrated in the drawing, the electrode lead structure may be an electrode lead structure including such an electrode lead as illustrated in FIG. 6.

As another embodiment, FIG. 8 illustrates an example of a secondary battery including the electrode lead as illustrated in FIG. 6 and having electrode tabs bonded to both surfaces of the electrode lead structure. As illustrated in the FIG. 8, an electrode uncoated portion extending from the electrode current collector of each electrode may be provided as an electrode tab, and the electrode tab may be bonded to both sides of the electrode lead to form an electrode tab bonded portion in the first lead portion region and may be electrically connected to an external instrument, such as an external power source or an external device, through the second lead portion. Meanwhile, although not illustrated in the drawing, the electrode lead structure may be an electrode lead structure including the electrode lead as illustrated in FIG. 5.

The bonding of the electrode tab and the electrode lead and the bonding of the electrode tabs are not particularly limited and may be formed by bonding a plurality of electrode tabs by a method, such as ultrasonic welding.

The secondary battery including the electrode lead structure as described above may reduce damage applied to the electrode tab extending from the electrode located at the outermost side of the electrode assembly and may weaken the tension, thereby effectively suppressing the problem of disconnection of the electrode tab. In addition, even when swelling occurs during the charging and discharging process of the battery, the tension may be relieved, thereby reducing the possibility of disconnection of the electrode tab located at the outermost side. Therefore, the secondary battery including the electrode lead according to an embodiment of the present disclosure may prevent a decrease in the lifespan of the battery and deterioration of energy storage performance.

The positive electrode may: include a positive electrode current collector and a positive electrode mixture layer disposed on at least one surface of the positive electrode current collector.

The positive electrode current collector may include stainless steel, nickel, aluminum, titanium, or alloys thereof. The positive electrode current collector may include aluminum surface-treated with carbon, nickel, titanium, or silver, or stainless steel surface-treated with carbon, nickel, titanium, or silver. In addition, the positive electrode current collector may be a polymer substrate coated with a conductive metal, such as nickel, aluminum, titanium, or silver. The positive electrode current collector may have various forms, such as, but not limited to, a foil, a foam, a net, a porous body, or a non-woven fabric. In addition, the positive electrode current collector may have a thickness of, but not limited to, 10 to 50 μm.

The positive electrode mixture layer may include a positive electrode active material. The positive electrode active material may include a compound capable of reversibly intercalating and deintercalating lithium ions. According to embodiments, the positive electrode active material may include a lithium-nickel metal oxide. The lithium-nickel metal oxide may further include at least one of cobalt (Co), manganese (Mn), and aluminum (Al).

In some embodiments, the positive electrode active material or the lithium-nickel metal oxide may include a layered structure or a crystal structure represented by Chemical Formula 1 below.

LiₓNiₐM_{b}O_{2+z} [Chemical Formula 1]

In Chemical Formula 1, 0.9≤x≤1.2, 0.6≤a≤0.99, 0.01≤b≤0.4, −0.5≤z≤0.1 may be satisfied, and as described above, M may include Co, Mn, and/or Al.

The chemical structure represented by Chemical Formula 1 represents a bonding relationship included in the layered structure or crystal structure of the positive electrode active material and does not exclude other additional elements. For example, M includes Co and/or Mn, and Co and/or Mn may be provided as the main active elements of the positive electrode active material together with Ni. Chemical formula 1 is provided to express the bonding relationship of the main active elements and should be understood as encompassing the introduction and substitution of additional elements.

In an embodiment, auxiliary elements may be further included in addition to the main active elements to enhance the chemical stability of the positive electrode active material or the layered structure/crystal structure. The auxiliary elements may be incorporated together in the layered structure/crystal structure to form a bond, and in this case, it should be understood that the auxiliary elements are also included within the chemical structure range represented by Chemical Formula 1.

The auxiliary elements may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, and Zr. The auxiliary elements may also act as auxiliary active elements contributing to the capacity/output activity of the positive electrode active material together with Co or Mn, for example, such as Al.

For example, the positive electrode active material or the lithium-nickel metal oxide may include a layered structure or a crystal structure represented by Chemical Formula 1-1.

LiₓNiₐM1_{b1}M2_{b2}O_{2+z} [Chemical Formula 1-1]

In Chemical Formula 1-1, M1 may include Co, Mn, and/or Al. M2 may include the auxiliary elements described above.

In Chemical Formula 1-1, 0.9≤x≤1.2, 0.65a≤0.99, 0.01≤b1+b2≤0.4, −0.5≤z≤0.1 may be satisfied.

The positive electrode active material may further include a coating element or a doping element. For example, elements substantially identical to or similar to the aforementioned auxiliary elements may be used as the coating element or the doping element. For example, one or two or more of the aforementioned elements may be used as the coating element or the doping element.

The coating element or the doping element may be present on a surface of the lithium-nickel metal oxide particle or may penetrate through the surface of the lithium-nickel metal oxide particle and be included in the bonding structure represented by Chemical Formula 1 or Chemical Formula 1-1.

The positive electrode active material may include a nickel-cobalt-manganese (NCM)-based lithium oxide. In this case, an NCM-based lithium oxide having an increased nickel content may be used.

Ni may be provided as a transition metal related to the output and capacity of a lithium secondary battery. Therefore, as described above, by employing a high-content (high-Ni) composition in the positive electrode active material, a high-capacity positive electrode and a high-capacity lithium secondary battery may be provided.

However, as the content of Ni increases, the long-term storage stability and lifespan stability of the positive electrode or the secondary battery may be relatively reduced, and side reactions with the electrolyte may also increase. However, according to embodiments, while maintaining the electrical conductivity by including Co, the lifespan stability and capacity retention characteristics may be improved through Mn.

The content of Ni in the NCM-based lithium oxide (for example, the mole fraction of nickel among the total moles of nickel, cobalt, and manganese) may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the positive electrode active material may include a Mn-rich active material, a Li rich layered oxide (LLO)/over lithiated oxide (OLO)-based active material, or a Co-less active material having a chemical structure or crystal structure represented by Chemical Formula 2, for example.

p[Li₂MnO₃]·(1−p)[Li_{q}JO₂] [Chemical Formula 2]

In Chemical Formula 2, 0<p<1, 0.9≤q≤1.2, and J may include at least one element among Mn, Ni, Co, Fe, Cr, V, Cu, Zn, Ti, Al, Mg, and B.

The positive electrode may be manufactured, for example, by mixing the positive electrode active material and a binder in a solvent to manufacture a positive electrode slurry, applying the positive electrode slurry on a positive electrode current collector, and then drying and rolling the same to form a positive electrode mixture layer.

The coating process may be performed by a method, such as gravure coating, slot die coating, multilayer simultaneous die coating, imprinting, doctor blade coating, dip coating, bar coating, casting, etc., but is not limited thereto.

Solvents used in the manufacture of the positive electrode slurry may include, but are not limited to, N-methyl-2-pyrrolidone (NMP), dimethylformamide, dimethylacetamide, N, N-dimethylaminopropylamine, ethylene oxide, tetrahydrofuran, etc.

The binder may include polyvinylidene fluoride (PVDF), poly(vinylidene fluoride-co-hexafluoropropylene) copolymer, polyacrylonitrile, polymethylmethacrylate, acrylonitrile butadiene rubber (NBR), polybutadiene rubber (BR), styrene-butadiene rubber (SBR), etc. In an embodiment, a PVDF series binder may be used as the positive electrode binder.

The positive electrode slurry may optionally further include a conductive agent. The conductive agent may be added to enhance the conductivity of the positive electrode mixture layer and/or the mobility of lithium ions or electrons. For example, the conductive agent may include, but is not limited to, a carbon-based conductive material, such as graphite, carbon black, acetylene black, ketjen black, graphene, carbon nanotubes, vapor-grown carbon fiber (VGCF), carbon fiber, and/or a metal-based conductive material including a perovskite material, such as tin, tin oxide, titanium oxide, LaSrCoO₃, LaSrMnO₃.

The positive electrode slurry may optionally further include a thickener, etc. If necessary, the positive electrode mixture layer may further include a thickener and/or a dispersant, etc. In an embodiment, the positive electrode mixture layer may include a thickener, such as carboxymethyl cellulose (CMC).

The negative electrode may include a negative electrode current collector and a negative electrode mixture layer disposed on at least one surface of the negative electrode current collector.

The negative electrode current collector may include stainless steel, copper, nickel, titanium, or alloys thereof. The negative electrode current collector may include copper surface-treated with carbon, nickel, titanium, or silver, or stainless steel surface-treated with carbon, nickel, titanium, or silver. In addition, the negative electrode current collector may be a polymer substrate coated with a conductive metal, such as nickel, aluminum, titanium, or silver. The negative electrode current collector may have various forms, such as a foil, a foam, a net, a porous body, or a non-woven body, etc., as non-limiting examples. In addition, the negative electrode current collector may have a thickness of 10 to 50 μm, but is not limited thereto.

The negative electrode mixture layer may include a negative electrode active material. A material capable of adsorbing and desorbing lithium ions may be used as the negative electrode active material. For example, as the negative electrode active material, a carbon-based material, such as crystalline carbon, amorphous carbon, carbon composite, carbon fiber, etc.; lithium metal; lithium alloy; silicon (Si)-containing material or tin (Sn)-containing material, etc. may be used.

Examples of the amorphous carbon may include hard carbon, soft carbon, coke, mesocarbon microbead (MCMB), mesophase pitch-based carbon fiber (MPCF), etc.

Examples of the crystalline carbon may include graphite-based carbon, such as natural graphite, artificial graphite, graphitized coke, graphitized MCMB, graphitized MPCF, etc.

The lithium metal may include pure lithium metal or lithium metal having a protective layer formed thereon to suppress dendrite growth, etc. In an embodiment, a lithium metal-containing layer deposited or coated on an negative electrode current collector may be used as the negative electrode active material layer. In an embodiment, a lithium thin film layer may be used as the negative electrode active material layer.

Elements included in the lithium alloy may include aluminum, zinc, bismuth, cadmium, antimony, silicon, lead, tin, gallium, or indium.

The silicon-containing material may provide increased capacity characteristics. The silicon-containing material may include Si, SiOx (0<x<2), metal-doped SiOx (0<x<2), silicon-carbon composites, etc. The metal may include lithium and/or magnesium, and the metal-doped SiOx (0<x<2) may include metal silicate.

For example, the negative electrode may be formed by preparing a negative electrode slurry through mixing the negative electrode active material in a solvent. The negative electrode mixture layer may further include a binder and optionally further include a conductive agent, a thickener, etc.

After coating/depositing the negative electrode slurry on the negative electrode current collector, drying and rolling may be performed to prepare a negative electrode mixture layer. The coating process may be performed by methods, such as gravure coating, slot die coating, multilayer simultaneous die coating, imprinting, doctor blade coating, dip coating, bar coating, casting, etc., but is not limited thereto.

In some embodiments, the negative electrode may include a negative electrode active material layer in the form of lithium metal formed through a deposition/coating process.

Non-limiting examples of the solvent for the negative electrode slurry may include water, pure water, deionized water, distilled water, ethanol, isopropanol, methanol, acetone, n-propanol, t-butanol, etc.

The binder may include polyvinylidene fluoride (PVDF), poly vinylidene fluoride-co-hexafluoropropylene copolymer, polyacrylonitrile, polymethylmethacrylate, acrylonitrile butadiene rubber (NBR), polybutadiene rubber (BR), styrene-butadiene rubber (SBR), etc. In an embodiment, a styrene-butadiene rubber (SBR)-based binder, carboxymethyl cellulose (CMC), a polyacrylic acid-based binder, a poly(3,4-ethylenedioxythiophene, PEDOT)-based binder, etc. may be used as the negative electrode binder.

The binder may be included in an amount of about 1.5 to about 5 wt % based on the total weight of the negative electrode mixture layer.

The negative electrode slurry may include a conductive agent. The conductive agent may be added to enhance the conductivity of the negative electrode mixture layer and/or the mobility of lithium ions or electrons. For example, the conductive agent may include, but is not limited to, a carbon-based conductive material, such as graphite, carbon black, acetylene black, Ketjen black, graphene, carbon nanotubes, vapor-grown carbon fiber (VGCF), carbon fiber, and/or a metal-based conductive material including a perovskite material, such as tin, tin oxide, titanium oxide, LaSrCoO₃, LaSrMnO₃.

In an embodiment, the conductive agent may be included in an amount of about 0.05 to about 0.2 wt % based on the total weight of the negative electrode mixture layer.

If necessary, the negative electrode slurry may further include a thickener and/or a dispersant. In an embodiment, the negative electrode mixture layer may include a thickener, such as carboxymethyl cellulose (CMC).

A separator may be interposed between the positive electrode and the negative electrode. The separator may be configured to prevent an electrical short-circuit between the positive electrode and the negative electrode and to generate ion flow. As an example, a thickness of the separator is not limited thereto, but may be, for example, 10 μm to 20 μm.

For example, the separator may include a porous polymer film or a porous nonwoven fabric. The porous polymer film may include a polyolefin polymer, such as an ethylene polymer, a propylene polymer, an ethylene/butene copolymer, an ethylene/hexene copolymer, and an ethylene/methacrylate copolymer. The porous nonwoven fabric may include a high-melting-point glass fiber, polyethylene terephthalate fibers, etc. The separator may also include a ceramic material. For example, inorganic particles may be coated on the polymer film or dispersed within the polymer film to improve heat resistance.

The separator may have a single-layer structure including the aforementioned polymer film and/or non-woven fabric or may have a multilayer structure.

An electrolyte may be accommodated in the battery case together with the electrode assembly to define a lithium secondary battery. According to an embodiment, the electrolyte may include a non-aqueous electrolyte.

The non-aqueous electrolyte may include a lithium salt as an electrolyte and an organic solvent, and the lithium salt is expressed as, for example, Li⁺X⁻, and anion (X⁻) of the lithium salt may include, for example, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO²)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

The organic solvent may include an organic compound having sufficient solubility for the lithium salt and additive and not having reactivity in the battery. The organic solvent may include, for example, at least one of a carbonate solvent, an ester solvent, an ether solvent, a ketone solvent, an alcohol solvent, and an aprotic solvent. As the organic solvent, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (diethylene Examples of suitable ethylene glycol dimethyl ether (DEGDME), dimethoxyethane, tetrahydrofuran (THF), 2-methyltetrahydrofuran, ethyl alcohol, isopropyl alcohol, dimethyl sulfur oxide, acetonitrile, dimethoxyethane, diethoxyethane, sulfolane, gamma-butyrolactone, propylene sulfite, or the like may be used. These may be used alone or two or more thereof may be used in combination.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, and a borate compound.

The cyclic carbonate compound may include vinylene carbonate (VC), vinyl ethylene carbonate (VEC), and the like.

The fluorine-substituted carbonate compound may include fluoroehtylene carbonate (FEC), and the like.

The sultone compound may include 1,3-propane sultone, 1,3-propene sultone, 1,4-butane sultone, and the like.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis-oxalato phosphate, lithium difluoro phosphate, etc.

The borate compound may include lithium bis(oxalate) borate, etc.

According to an embodiment of the present disclosure, even if the volume of the battery shrinks and swells during the charging and discharging process of the battery, the disconnection of the electrode tab may be prevented.

In addition, according to another embodiment of the present disclosure, lifespan shortening of the battery may be prevented and storage performance may be improved.

The secondary battery of the present disclosure may be widely applied in green technology fields, such as electric vehicles, battery charging stations, and solar power generation and wind power generation using batteries. In addition, the secondary battery of the present disclosure may be used in eco-friendly electric vehicles, hybrid vehicles, etc. to prevent climate change by suppressing air pollution and greenhouse gas emissions.

Only specific examples of implementations of certain embodiments are described. Variations, improvements and enhancements of the disclosed embodiments and other embodiments may be made based on the disclosure of this patent document.

What is claimed is:

1. An electrode lead structure for a secondary battery, the electrode lead structure comprising:
an electrode lead and a lead film,
wherein the electrode lead includes a first lead portion to which an electrode tab is bonded; a second lead portion, having a thickness less than that of the first lead portion; and a third lead portion formed between the first lead portion and the second lead portion and having a slope in which a thickness increases in a direction from the second lead portion to the first lead portion, and
the lead film is positioned on the third lead portion.

2. The electrode lead structure of claim 1, wherein the first lead portion is less than a thickness of an electrode assembly.

3. The electrode lead structure of claim 1, wherein the thickness of the second lead portion is 200 μm to 1.2 mm.

4. The electrode lead structure of claim 1, wherein the electrode lead is a negative electrode lead, and the thickness of the second lead portion is 200 μm to 600 μm.

5. The electrode lead structure of claim 1, wherein the electrode lead is a positive electrode lead, and the thickness of the second lead portion is 200 μm to 1 mm.

6. The electrode lead structure of claim 1, wherein a thickness ratio of the first lead portion and the second lead portion is 1.1 to 3:1.

7. The electrode lead structure of claim 1, wherein a width of the third lead portion is greater than a width of the lead film.

8. The electrode lead structure of claim 1, wherein a width of the third lead portion is 10 to 30% greater than a width of the lead film.

9. The electrode lead structure of claim 1, wherein the slope of the third lead portion is formed only on one surface of the electrode lead.

10. The electrode lead structure of claim 1, wherein the slope of the third lead portion is formed on both surfaces of the electrode lead.

11. The electrode lead structure of claim 10, wherein, in the slope formed on both surfaces, slope angles between the first lead portion and the second lead portion are different from each other.

12. A secondary battery comprising:
an electrode assembly;
an electrode tab disposed at at least one end portion of the electrode assembly; and
an electrode lead structure bonded to the electrode tab,
wherein the electrode lead structure is the electrode lead structure of claim 1.

13. The secondary battery of claim 12, wherein the electrode tab is bonded to one or both surfaces of the first lead portion of the electrode lead structure.

14. The secondary battery of claim 12, wherein the secondary battery is a lithium secondary battery.
